(19) United States
(12) Patent Application Publication
(10) Pub. No.: US 2023/0164818 A1
(43) Pub. Date: May 25, 2023

(54) ENABLING APERIODIC CSI AND SRS TRANSMISSIONS FOR SCELL DORMANCY

(71) Applicant: Telefonaktiebolaget LM Ericsson (publ), STOCKHOLM (SE)

(72) Inventors: Ajit Nimbalker, FREMONT, CA (US); Ravikiran Nory, SAN JOSÉ, CA (US)

(21) Appl. No.: 17/921,904

(22) PCT Filed: Apr. 27, 2021
(86) PCT No.: PCT/IB2021/053482

§ 371 Date: Oct. 27, 2022

Related U.S. Application Data
(60) Provisional application No. 63/016,233, filed on Apr. 27, 2020.

(51) Int. Cl. H04W 72/51; H04W 72/0457; H04L 5/00

(52) U.S. Cl. CPC H04W 72/51; H04W 72/0457; H04L 5/0051

(57) ABSTRACT

Systems and methods are disclosed herein that relate to enabling Sounding Reference Signal (SRS) transmissions and Aperiodic Channel State Information (A-CSI) for Secondary Cell (SCell) dormancy. In one embodiment, a method performed by a wireless communication device comprises transmitting, to a network node, first capability information that indicates that the wireless communication device supports SCell dormancy operation using a dormant bandwidth part (BWP) for one or more SCells. The method further comprises transmitting, to the network node, second capability information that indicates whether the wireless communication device supports sounding reference signal, SRS, transmission on a dormant BWP of one or more SCells. In this manner, efficient and flexible operation of SCell dormancy is provided.

### RELATED APPLICATIONS

This application claims the benefit of U.S. Provisional Patent Application No. 63/016,233, filed Apr. 27, 2020, the disclosure of which is hereby incorporated herein by reference in its entirety.

### TECHNICAL FIELD

The present disclosure relates to Aperiodic Channel State Information (A-CSI) measurement and reporting as well as Sounding Reference Signal (SRS) transmissions for Secondary Cell (SCell) dormancy in a cellular communications system.

### BACKGROUND

### Carrier Aggregation

Carrier Aggregation (CA) is generally used in Fifth Generation (5G) New Radio (NR) and Long Term Evolution (LTE) systems to improve User Equipment (UE) transmit and receive data rate. With CA, the UE typically operates initially on single serving cell called a Primary Cell (PCell). The PCell is operated on a Component Carrier (CC) in a frequency band. The UE is then configured by the network with one or more Secondary Serving Cells (SCells). Each SCell can correspond to a CC in the same frequency band as the CC corresponding to the PCell (intra-band CA) or a CC in a different frequency band from the frequency band of the CC corresponding to the PCell (inter-band CA). For the UE to transmit/receive data on the SCell(s) (e.g., by receiving Downlink Shared Channel (DL-SCH) information on a Physical Downlink Shared Channel (PDSCH) or by transmitting Uplink Shared Channel (UL-SCH) information on a Physical Uplink Shared Channel (PUSCH)), the SCell(s) need to be activated by the network. The SCell(s) can also be deactivated and later reactivated as needed via activation/deactivation signaling.

### SCell Activation/Deactivation in NR Release 15

FIG. 1 illustrates SCell activation/deactivation related procedures specified for Release 15 NR. As shown in FIG. 1, except for Channel State Information (CSI) reporting, the UE is allowed to start performing other ‘activation related actions’ (e.g. Physical Downlink Control Channel (PDCCH) monitoring for SCell, Physical Uplink Control Channel (PUCCH)/Sounding Reference Signal (SRS) transmission on the SCell) within a specified range of slots, i.e., after the minimum required activation delay (specified in Third Generation Partnership Project (3GPP) Technical Specification (TS) 38.213) and before the maximum allowed activation delay (specified in 3GPP TS 38.133). CSI reporting for the SCell starts (or stops) with a fixed slot offset after receiving the activation (or deactivation) command.

Below, the minimum required activation delay and maximum allowed activation delay are shown for some example conditions.
The minimum required activation delay is k1+3 ms+1 slots as specified 3GPP TS 38.213 subclause 4.3. Assuming 30 kilohertz (kHz) numerology for the PCell, and k1=4, this would be 5.5 ms.
The maximum allowed activation delay depends on conditions described in 3GPP TS 38.133 subclause 8.3.2, and the value varies based on UE measurement configuration, operating frequency range, and other aspects.
   Assuming T_HARQ in 3GPP TS 38.133 has similar meaning as k1 in 3GPP TS 38.213, and assuming ‘known SCell’ with SCell measurement cycle is equal to or smaller than 160 ms, and T_csi_reporting=4 slots:
      For Frequency Range 1 (FR1) and 30 kHz subcarrier spacing (SCS),
         If the Synchronization Signal (SS)/Physical Broadcast Channel (PBCH) Block (SSB) Measurement Time Configuration (SMTC) periodicity is 5 ms, the delay cannot be larger than (T_HARQ=4 slots)+(T_act_time=5 ms+5 ms)+(T_csi_report=4 slots)=14 ms;
         If SMTC periodicity 20 ms, the delay cannot be larger than (T_HARQ=4 slots)+(T_act_time=5 ms+20 ms)+(T_csi_report=4 slots)=29 ms.
      For Frequency Range 2 (FR2), assuming this is the first SCell being activated in that FR2 band,
         If SMTC periodicity 5 ms, the delay is 4 slots+5 ms+TBD*5 ms+4 slots=6 ms+X*5 ms;
         If SMTC periodicity 20 ms, the delay is 4 slots+5 ms+TBD*20 ms+4 slots=6 ms+X*20 ms;
         X>1 is to be determined (TBD) in current Release 15 specifications.
            For other conditions, e.g., SCell is not ‘known’ and longer SMTC periodicities, the maximum allowed activation delay is much longer than the values in the above example.

### Bandwidth Parts (BWPs)

In NR, a subset of the total cell bandwidth of a cell is referred to as a Bandwidth Part (BWP), and bandwidth adaptation is achieved by configuring the UE with a BWP(s) and telling the UE which of the configured BWPs is currently the active one.

FIG. 2 describes a scenario where three different BWPs are configured. The three configured BWPs in this scenario are:
BWP₁ with a width of 40 Megahertz (MHz) and subcarrier spacing of 15 kHz;
BWP₂ with a width of 10 MHz and subcarrier spacing of 15 kHz;
BWP₃ with a width of 20 MHz and subcarrier spacing of 60 kHz.

In NR, two options for configuring BWP #0 (i.e., the “initial BWP”) were specified (i.e., Option 1 and Option 2 described in Annex B.2 of 3GPP TS 38.331). When the BWP configuration includes UE-specific information (e.g., Information Elements (IEs) like ServingCellconfig), that BWP can be considered as a UE-specific Radio Resource Control (RRC) configured BWP. FIG. 3 illustrates BWP #0 configuration without dedicated configuration (i.e., Option 1). FIG. 4 illustrates BWP #0 configuration with dedicated configuration (i.e., Option 2).

### SUMMARY

Systems and methods are disclosed herein that relate to enabling Sounding Reference Signal (SRS) transmissions and Aperiodic Channel State Information (A-CSI) for Secondary Cell (SCell) dormancy. In one embodiment, a method performed by a wireless communication device comprises transmitting, to a network node, first capability information that indicates that the wireless communication device supports SCell dormancy operation using a dormant bandwidth part (BWP) for one or more SCells. The method further comprises transmitting, to the network node, second capability information that indicates whether the wireless communication device supports sounding reference signal, SRS, transmission on a dormant BWP of one or more SCells. In this manner, efficient and flexible operation of SCell dormancy is provided.

In one embodiment, the method further comprises switching to a dormant BWP of an SCell and, upon switching to the dormant BWP of the SCell, performing one or more actions in accordance with the first capability information and the second capability information.

In one embodiment, the second capability information indicates that the wireless communication device does not support aperiodic SRS transmission on a dormant BWP of one or more SCells, and the one or more actions comprise: (a) stop receiving Physical Downlink Control Channel (PDCCH) for the SCell, (b) do not receive Downlink Shared Channel (DL-SCH) on the SCell, (c) perform periodic SRS reporting, (d) perform any semi-persistent SRS reporting, or (e) a combination of any two or more of (a)-(d). In one embodiment, aperiodic SRS transmission for the SCell cannot be triggered for the wireless communication device.

In one embodiment, the second capability information indicates that the wireless communication device does support aperiodic SRS transmission on a dormant BWP of one or more SCells, and the one or more actions comprise transmitting aperiodic SRS on the SCell.

In one embodiment, the second capability information indicates that the wireless communication device does support periodic SRS transmission on a dormant BWP of one or more SCells, and the one or more actions comprise transmitting periodic SRS on the SCell.

In one embodiment, the one or more actions further comprise transmitting a measurement report on a cell other than the SCell.

In one embodiment, the second capability information comprises one or more parameters comprising: (i) one or more parameters associated with SRS transmission on a dormant BWP of one or more SCells, (ii) one or more parameters associated with A-SRS transmission on another cell, or (iii) both (i) and (ii). In one embodiment, the one or more parameters comprises an aperiodic SRS triggering offset or a minimum value of an A-SRS triggering offset. In one embodiment, the one or more parameters comprise a parameter that defines a gap between an end of a PDCCH on a triggering cell that triggers aperiodic SRS transmission and a start of SRS transmission on a cell on which the SRS transmission is triggered. In one embodiment, a value of the parameter that defines the gap is based on an SCell dormancy transition time that the wireless communication device reports. In one embodiment, the one or more parameters comprise a minimum value of an A-SRS triggering offset, and the minimum value of the A-SRS triggering offset is dependent on a subcarrier spacing of a cell on which a PDCCH triggering aperiodic SRS transmission is received by the wireless communication device. In one embodiment, the one or more parameters comprise a minimum value of an A-SRS triggering offset, and the minimum value of the A-SRS triggering offset is dependent on a subcarrier spacing of a cell on which a PDCCH triggering aperiodic SRS transmission is received by the wireless communication device and the subcarrier spacing of the SCell.

In one embodiment, the method further comprises transmitting assistance information to the network node that informs the network node of a preferred A-SRS triggering offset or a minimum gap for dormant BWP operation.

In one embodiment, the second capability information indicates that the wireless communication device does not support A-SRS transmission on a dormant BWP of one or more SCells under one or more certain conditions.

Corresponding embodiments of a wireless communication device are also disclosed. In one embodiment, a wireless communication device is adapted to transmit, to a network node, first capability information that indicates that the wireless communication device supports SCell dormancy operation using a dormant BWP for one or more SCell and transmit, to the network node, second capability information that indicates whether the wireless communication device supports SRS transmission on a dormant BWP of one or more SCells.

In one embodiment, a wireless communication device comprises one or more transmitters, one or more receivers, and processing circuitry associated with the one or more transmitters and the one or more receivers. The processing circuitry is configured to cause the wireless communication device to transmit, to a network node, first capability information that indicates that the wireless communication device supports SCell dormancy operation using a dormant BWP for one or more SCell and transmit, to the network node, second capability information that indicates whether the wireless communication device supports SRS transmission on a dormant BWP of one or more SCells.

In another embodiment, a method performed by a wireless communication device comprises transmitting, to a network node, first capability information that indicates that the wireless communication device supports SCell dormancy operation using a dormant BWP for one or more SCells and transmitting, to the network node, second capability information that indicates whether the wireless communication device supports A-CSI measurement on a dormant BWP of one or more SCells.

In one embodiment, the method further comprises switching to a dormant BWP of an SCell and, upon switching to the dormant BWP of the SCell, performing one or more actions in accordance with the first capability information and the second capability information.

In one embodiment, the second capability information indicates that the wireless communication device does not supports A-CSI measurement on a dormant BWP of one or more SCells, and the one or more actions comprise: (a) stop PDCCH for the SCell, (b) do not receive DL-SCH on the SCell, (c) perform periodic CSI reporting, (d) perform semi-persistent CSI reporting, or (e) a combination of any two or more of (a)-(d).

In one embodiment, A-CSI measurements for the SCell cannot be triggered for the wireless communication device. In one embodiment, the second capability information indicates that the wireless communication device does support A-CSI measurement on a dormant BWP of one or more SCells, and the one or more actions comprise measuring A-CSI using CSI-RS on the SCell and transmitting, on a cell other than the SCell, a measurement report that comprises at least a subset of the A-CSI measurements or information derived from at least a subset of the A-CSI measurements. In one embodiment, a PDCCH that triggers the A-CSI measurement on the dormant BWP of the SCell is received by the wireless communication device on a cell other than the SCell. In one embodiment, a cell on which the PDCCH that triggers the A-CSI measurement on the dormant BWP of the SCell is received by the wireless communication device is a same cell on which the wireless communication device transmits the measurement report. In another embodiment, a cell on which the PDCCH that triggers the A-CSI measurement on the dormant BWP of the SCell is received by the wireless communication device is a cell other than a cell on which the wireless communication device transmits the measurement report.

In one embodiment, the second capability information comprises one or more parameters comprising: (i) one or more parameters associated with A-CSI measurement on a dormant BWP of one or more SCells, (ii) one or more parameters associated with A-CSI measurement reporting on another cell, or (iii) both (i) and (ii). In one embodiment, the one or more parameters comprise an A-CSI triggering offset or a minimum value of an A-CSI triggering offset. In one embodiment, the one or more parameters comprise a parameter that defines a gap between an end of a PDCCH on a triggering cell that triggers A-CSI measurement and a start of CSI-RS on a cell on which the A-CSI measurement is triggered. In one embodiment, a value of the parameter that defines the gap is based on an SCell dormancy transition time that the wireless communication device reports.

In one embodiment, the one or more parameters comprise a minimum value of an A-CSI triggering offset, and the minimum value of the A-CSI triggering offset is dependent on a subcarrier spacing of a cell on which a PDCCH triggering A-CSI measurement is received by the wireless communication device.

In one embodiment, the one or more parameters comprise a minimum value of an A-CSI triggering offset, and the minimum value of the A-CSI triggering offset is dependent on a subcarrier spacing of a cell on which a PDCCH triggering A-CSI measurement is received by the wireless communication device and a subcarrier spacing of the SCell.

In one embodiment, the second capability information indicates a capability to support A-CSI measurement on a dormant BWP of one or more SCells only if the wireless communication device also indicates a capability to support operation using a minimum scheduling offset between reception of a PDCCH and corresponding Physical Downlink Shared Channel (PDSCH)/aperiodic CSI-RS triggering by the PDCCH.

In one embodiment, the method further comprises transmitting assistance information to the network node that informs the network node of a preferred A-CSI triggering offset or a minimum gap for dormant BWP operation.

In one embodiment, the second capability information is different from capability information that the wireless communication device uses to indicate support of A-CSI measurement on BWP(s) other than dormant BWP(s).

In one embodiment, the second capability information indicates that the wireless communication device does not support A-CSI measurement on a dormant BWP of one or more SCells under one or more certain conditions.

Corresponding embodiments of a wireless communication device are also disclosed. In one embodiment, a wireless communication device is adapted to transmit, to a network node, first capability information that indicates that the wireless communication device supports SCell dormancy operation using a dormant BWP for one or more SCells. The wireless communication device is further adapted to transmit, to the network node, second capability information that indicates whether the wireless communication device supports A-CSI measurement on a dormant BWP of one or more SCells.

In one embodiment, a wireless communication device comprises one or more transmitters, one or more receivers, and processing circuitry associated with the one or more transmitters and the one or more receivers. The processing circuitry is configured to cause the wireless communication device to transmit, to a network node, first capability information that indicates that the wireless communication device supports SCell dormancy operation using a dormant BWP for one or more SCells. The processing circuitry is further configured to cause the wireless communication device to transmit, to the network node, second capability information that indicates whether the wireless communication device supports A-CSI measurement on a dormant BWP of one or more SCells.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates Secondary Cell (SCell) activation/deactivation related procedures specified for Third Generation Partnership Project (3GPP) New Radio (NR) Release 15;

FIG. 2 illustrates a scenario in which three different bandwidth parts (BWPs) are configured for a User Equipment (UE);

FIG. 3 illustrates BWP #0 configuration without dedicated configuration (i.e., Option 1 in NR Release 15);

FIG. 4 illustrates BWP #0 configuration with dedicated configuration (i.e., Option 2 in NR Release 15).

FIG. 5 illustrates one example of a cellular communications system in which embodiments of the present disclosure may be implemented;

FIG. 6 is a flow chart that illustrates the operation of a UE in relation to capability indication for Aperiodic Channel State Information (A-CSI) measurement on a dormant BWP on one or more SCells and reporting in accordance with some embodiments of the present disclosure;

FIG. 7 is a flow chart that illustrates the operation of a UE in relation to capability indication for A-CSI measurement on a dormant BWP on one or more SCells and reporting in accordance with some embodiments of the present disclosure;

FIG. 8 is a flow chart that illustrates the operation of a UE in relation to capability indication for Aperiodic Sounding Reference Signal (A-SRS) transmission on a dormant BWP on one or more SCells in accordance with some embodiments of the present disclosure;

FIG. 9 is a flow chart that illustrates the operation of a UE in relation to capability indication for A-SRS transmission on a dormant BWP on one or more SCells in accordance with some embodiments of the present disclosure;

FIGS. 10, 11, and, 12 are schematic block diagrams of example embodiments of a network node; and

FIGS. 13 and 14 are schematic block diagrams of example embodiments of a wireless communications device;

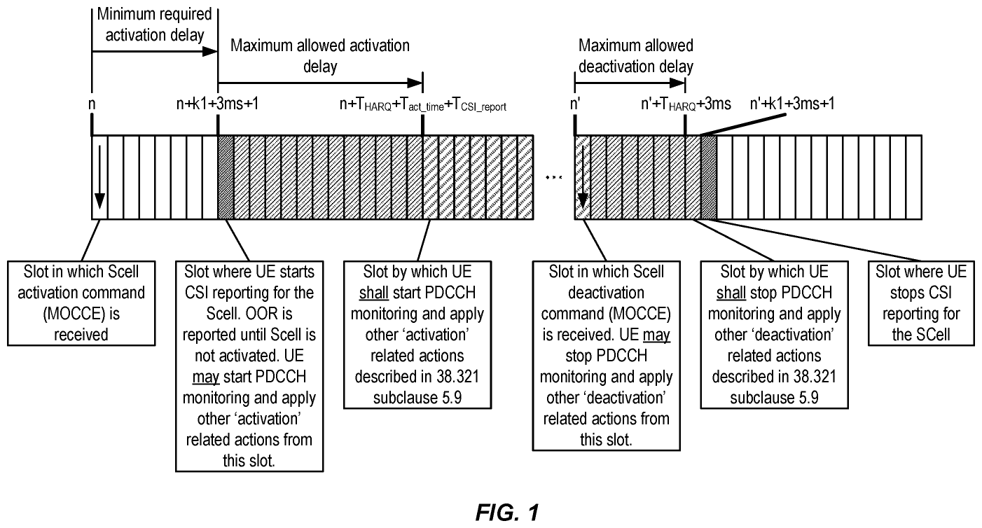

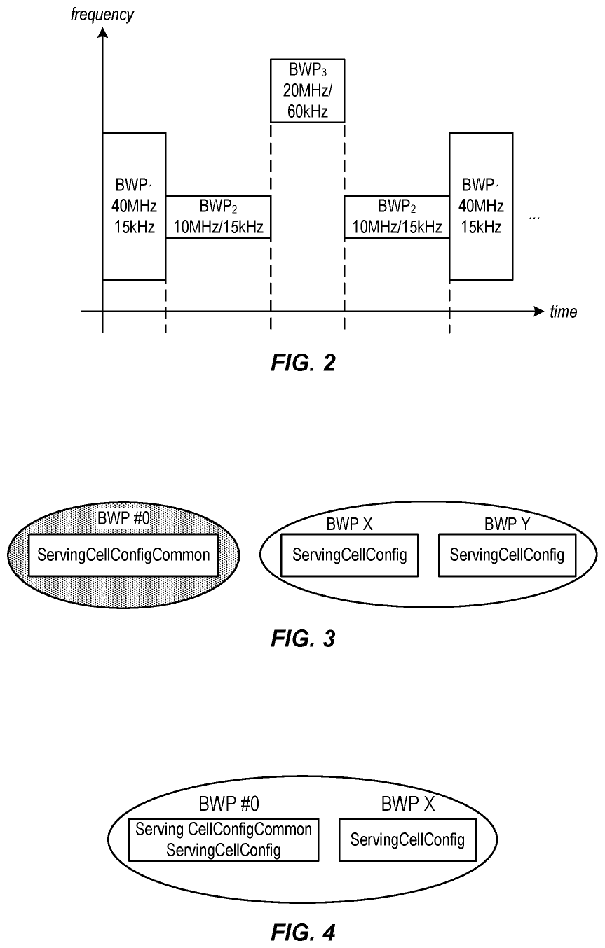

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). Aperiodic Channel State Information (CSI) (A-CSI) measurement made on a dormant Secondary Cell (SCell) and corresponding reporting on another cell and Sounding Reference Signal (SRS) (periodic/aperiodic) transmission on a dormant SCell can increase UE power consumption. Existing solutions therefore favor precluding support of A-CSI measurement and SRS transmission on a dormant SCell. However, this increases latency in transition from a dormant bandwidth part (BWP) to data scheduling for downlink, and similarly increases latency in transition from a dormant BWP to uplink data scheduling.

Certain aspects of the present disclosure and their embodiments may provide solutions to the aforementioned or other challenges. Embodiments of the proposed solution allow UE capability signaling where a UE can perform any one or any combination of the following actions:
The UE can use capability and/or assistance signaling to indicate its support of A-CSI measurement made on a dormant BWP when the dormant BWP is active, and corresponding reporting on another cell. The UE can additionally indicate preferred configurations that allow operation in a dormant BWP and still have acceptable impact on UE power consumption (e.g., A-CSI triggering offset values, etc.). UE assistance framework can also be used to complement or augment the UE capability signaling.
The UE can use capability and/or assistance signaling to indicate its support of SRS transmission on the uplink when a dormant BWP is active. The UE can additionally indicate preferred configurations that allow operation in a dormant BWP and still have acceptable impact on UE power consumption (e.g., A-SRS triggering offset values, minimum periodicity of periodic SRS, etc.).

Certain embodiments may provide one or more of the following technical advantage(s). Embodiments of the solution described herein may enable efficient and flexible operation of SCell dormancy UEs can choose between different levels of tradeoff (e.g., power savings vs latency degradation) and indicate a corresponding preference(s) via UE capability/assistance signaling. Embodiments of the solution described herein may also enable the network to choose suitable configurations to ensure proper SCell dormancy operation and make full use of UE enhanced functionality offered by different UEs.

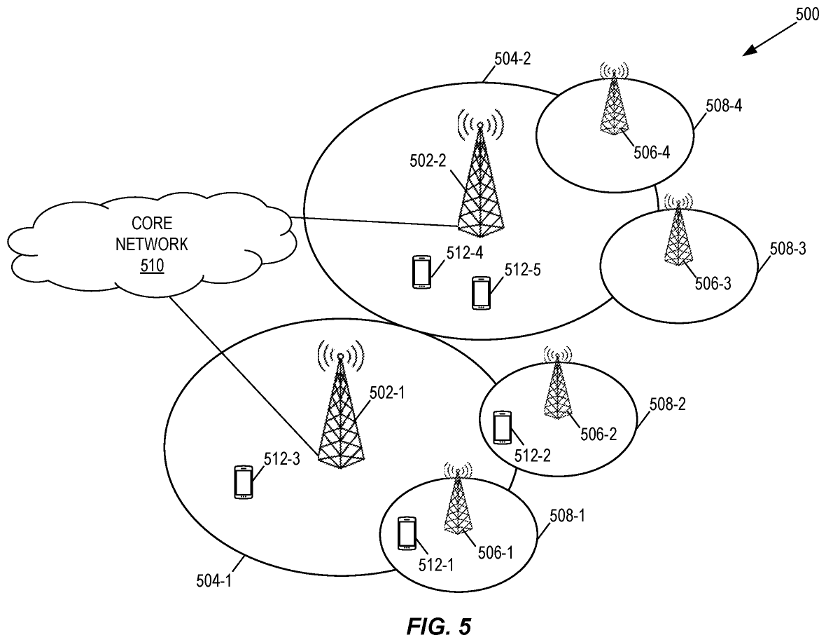

FIG. 5 illustrates one example of a cellular communications system 500 in which embodiments of the present disclosure may be implemented. In the embodiments described herein, the cellular communications system 500 is a 5G System (5GS) including a Next Generation RAN (NG-RAN) and a 5G Core (5GC). In this example, the RAN includes base stations 502-1 and 502-2, which in the 5GS include NR base stations (gNBs) and optionally next generation eNBs (ng-eNBs) (i.e., LTE RAN nodes connected to the 5GC), controlling corresponding (macro) cells 504-1 and 504-2. The base stations 502-1 and 502-2 are generally referred to herein collectively as base stations 502 and individually as base station 502. Likewise, the (macro) cells 504-1 and 504-2 are generally referred to herein collectively as (macro) cells 504 and individually as (macro) cell 504. The RAN may also include a number of low power nodes 506-1 through 506-4 controlling corresponding small cells 508-1 through 508-4. The low power nodes 506-1 through 506-4 can be small base stations (such as pico or femto base stations) or Remote Radio Heads (RRHs), or the like. Notably, while not illustrated, one or more of the small cells 508-1 through 508-4 may alternatively be provided by the base stations 502. The low power nodes 506-1 through 506-4 are generally referred to herein collectively as low power nodes 506 and individually as low power node 506. Likewise, the small cells 508-1 through 508-4 are generally referred to herein collectively as small cells 508 and individually as small cell 508. The cellular communications system 500 also includes a core network 510, which in the 5GS is referred to as the 5G Core (5GC). The base stations 502 (and optionally the low power nodes 506) are connected to the core network 510.

The base stations 502 and the low power nodes 506 provide service to wireless communication devices 512-1 through 512-5 in the corresponding cells 504 and 508. The wireless communication devices 512-1 through 512-5 are generally referred to herein collectively as wireless communication devices 512 and individually as wireless communication device 512. In the following description, the wireless communication devices 512 are oftentimes UEs and, as such, are often referred to as UEs 512; however, the present disclosure is not limited thereto.

Now, a description of details of embodiments of the present disclosure will be provided.

### UE Capability of A-CSI Measurement Made on Dormant BWP and Reporting on Another Cell

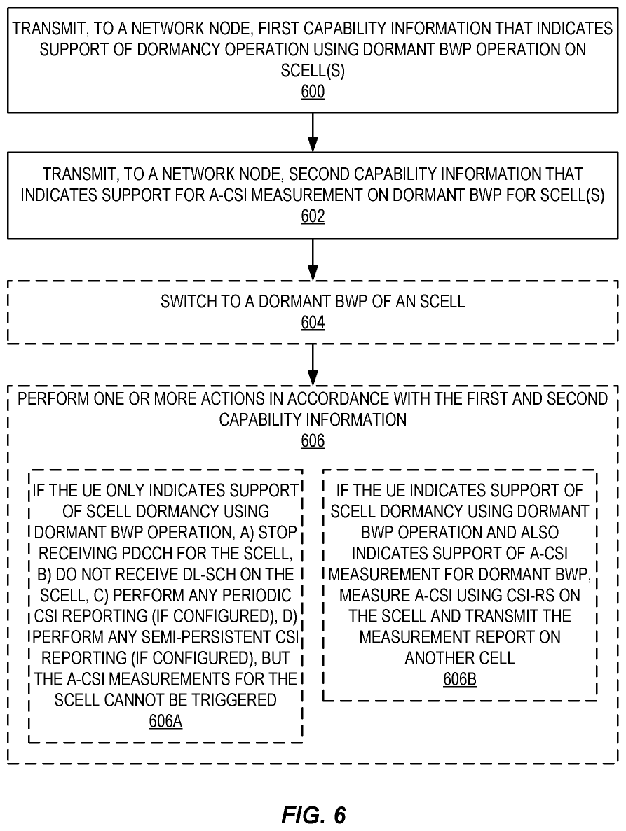

FIG. 6 is a flow chart that illustrates the operation of a UE 512 in accordance with some embodiments of the present disclosure. Optional steps are represented by dashed lines/boxes. As illustrated, the UE 512 indicates a first capability indicating support of SCell dormancy operation using a dormant BWP operation for one or more SCells (step 600). In other words, the UE 512 transmits the first capability (also referred to herein as first capability information) to a network node. The UE 512 may indicate a separate second capability indicating support of A-CSI measurement on dormant BWP for one or more SCells (step 602). In other words, the UE 512 may transmit second capability (also referred to herein as second capability information) to a network node (e.g., the same network node to which the first capability information is transmitted).

The UE 512 is switched to a dormant BWP of an SCell (step 604). The UE 512 performs one or more actions in accordance with the first and second capability information (step 606).

In one embodiment, if the UE 512 indicates support of SCell dormancy using dormant BWP operation without indicating support of A-CSI measurement for dormant BWP, when the UE 512 is switched to a dormant BWP of an SCell, the UE 512 a) stops receiving Physical Downlink Control Channel (PDCCH) for the SCell, b) does not receive Downlink Shared Channel (DL-SCH) on the SCell, c) performs any periodic CSI reporting (if configured), d) performs any semi-persistent CSI reporting (if configured), but the A-CSI measurements for the SCell cannot be triggered for that UE 512 (step 606A).

If the UE 512 indicates support of SCell dormancy using dormant BWP operation and also indicates support of A-CSI measurement for dormant BWP, when the UE 512 is switched to a dormant BWP of an SCell, the UE can measure A-CSI using CSI-RS on the SCell and transmit the measurement report on another cell (e.g., PCell/PSCell or another scheduling cell) (step 606B). The PDCCH to trigger the A-CSI measurement on the dormant BWP of SCell can be received by the UE on another cell (e.g., PCell/PSCell). The cell on which the trigger is received and the cell on which the CSI measurement report is transmitted can be the same cell or different cells. In addition to A-CSI measurements, the UE can perform other operations (e.g., any one or more and possibly all of operations a)-d) mentioned above) when switched to the dormant BWP.

The second UE capability indicating support of A-CSI measurement on a dormant BWP for one or more SCells can include one or more parameter settings associated with A-CSI measurement on the dormant BWP or associated with the A-CSI reporting on another cell (such as a PCell). The one or more parameters can include, e.g., an aperiodic CSI triggering offset, a minimum value of A-CSI triggering offset, etc. The one or more parameters can include a gap between the end of PDCCH on the triggering cell and the start of CSI-RS on the triggered cell. This gap can be in units of absolute time (e.g., ms) or in units of PDCCH symbols. An example with PDCCH symbols is shown below. This can be a first set of values that a UE can indicate it supports. The network can suitably configure the UE with A-CSI measurement in the dormant BWP and configure the UE with reporting based on the UE reported value.

| PDCCH SCS | Gap (in PDCCH symbols) |
|---|---|
| 15 kHz | 14 = (1 ms) |
| 30 kHz | 14 = (0.5 ms) |
| 60 kHz | 28 = (0.5 ms) |
| 120 kHz | 48 = (0.5 ms) |

The UE 512 may indicate a different value of the gap based on the SCell dormancy transition time that it reports. Thus, if the UE 512 indicates 3 ms for dormancy/non-dormancy transition, the same 3 ms can be used as the minimum gap for configuring A-CSI measurement in dormant BWP.

The minimum value of A-CSI triggering offset can be dependent on the SCS of triggering cell (e.g., PDCCH of primary cell if primary cell is triggering cell) and the SCS of the secondary cell (cell and BWP on which the A-CSI is triggered).

In some cases, the UE 512 may indicate the capability to support A-CSI measurement on a dormant BWP only if it also indicates the capability to support operation using a minimum scheduling offset (K0 configuration) between PDCCH reception and corresponding PDSCH/aperiodic CSI-RS triggering by the PDCCH.

In some cases, the UE 512 may indicate the capability to support A-CSI measurement on a dormant BWP only for certain Carrier Aggregation (CA) cases, e.g., for a case when the triggering PDCCH on cell 1 and the corresponding CSI-RS on cell 2 with a dormant BWP on which the CSI is measured have different SCS (sub-carrier spacing) configuration.

An example of capability description is shown below.

| | | | | | Type |
|---|---|---|---|---|---|
| | | | | | (the ‘type’ definition |
| | | | | | from UE features should be |
| | | | | | based on the granularity of |
| | | | | | 1) Per UE or |
| | | | | | 2) Per Band or |
| | | | Prerequisite | Consequence if the | 3) Per BC or |
| | Feature | | feature | feature is not | 4) Per FS or |
| Index | group | Components | groups | supported by the UE | 5) Per FSPC) |
| 18-4 | SCell | Support for SCell | | | Per UE |
| | dormancy | dormancy indication | | | |
| | within | sent within the active | | | |
| | active time | time on PCell with | | | |
| | | DCI format 0_1/1_1 | | | |
| 18-4d | Aperiodic | Support for A-CSI | 18-4 | UE cannot be | Per band per band |
| | CSI for | measurement on | | configured with | combination |
| | SCell | dormant SCell and | | A-CSI-RS on dormant | |
| | dormancy | corresponding report | | BWP | |
| | outside | on another cell | | | |
| | active time | | | | |

In another example, using an assistance signaling framework, the UE 512 can inform the network (e.g., base station 502) of a preferred A-CSI triggering offset or a minimum gap that the UE 512 prefers for dormant BWP operation. The network can use this assistance information for properly configuring the triggering offsets for the dormant BWP. The preferred A-CSI triggering offset can be different than the preferred A-CSI triggering offset the UE 512 can report for a BWP other than dormant BWP.

The UE indication of support of A-CSI measurement on a dormant BWP can be different from the capability that UE uses to indicate support of A-CSI measurement on BWP other than dormant BWP.

Another embodiment is described below.

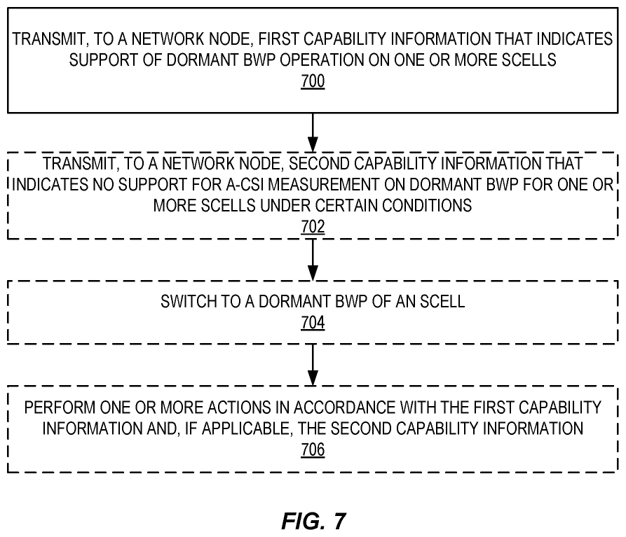

In this other embodiment, as illustrated in FIG. 7, the UE 512 indicates a first capability(-ies) that indicates that the UE 512 supports dormant BWP operation for one or more SCells (step 700). The UE 512 may indicate a second capability that indicates that the UE 512 does NOT support of A-CSI measurement on a dormant BWP for one or more SCells under certain conditions (702). The second UE capability can include one or more parameter settings associated with A-CSI measurement on the dormant BWP or associated with the A-CSI reporting on another cell (such as a PCell). The one or more parameters can include, for example, an aperiodic CSI triggering offset, a minimum value of A-CSI triggering offset, etc.

A UE 512 indicating the first capability only (i.e., indicating on that the UE 512 supports dormant BWP operation for one or more SCells) can be configured with dormant BWP and A-CSI measurement on the dormant BWP.

A UE 512 indicating both capabilities (i.e., indicating on that the UE 512 supports dormant BWP operation for one or more SCells and also indicating that the UE 512 does NOT support of A-CSI measurement on a dormant BWP for one or more SCells under certain conditions) cannot be configured with a dormant BWP and A-CSI measurement on the dormant BWP under those certain conditions.

The UE 512 is switched to a dormant BWP of an SCell (step 704). The UE 512 performs one or more actions in accordance with the first and second capability information (step 706). If UE 512 indicated the first capability only (i.e., indicating on that the UE 512 supports dormant BWP operation for one or more SCells), the UE 512 can be configured with dormant BWP and A-CSI measurement on the dormant BWP and, therefore, the UE 512 operates accordingly. They UE 512 may thereafter perform the corresponding measurement. If the UE 512 indicated both capabilities (i.e., indicates that the UE 512 supports dormant BWP operation for one or more SCells and also indicates that the UE 512 does NOT support of A-CSI measurement on a dormant BWP for one or more SCells under certain conditions), the UE 512 cannot be configured with a dormant BWP and A-CSI measurement on the dormant BWP under those certain conditions and, as such, the UE 512 operates accordingly to perform corresponding measurements.

The principles described above can be applied for SRS transmission in the dormant BWP as described below.

### UE Capability of SRS Transmission Made on Dormant BWP and Reporting on Another Cell

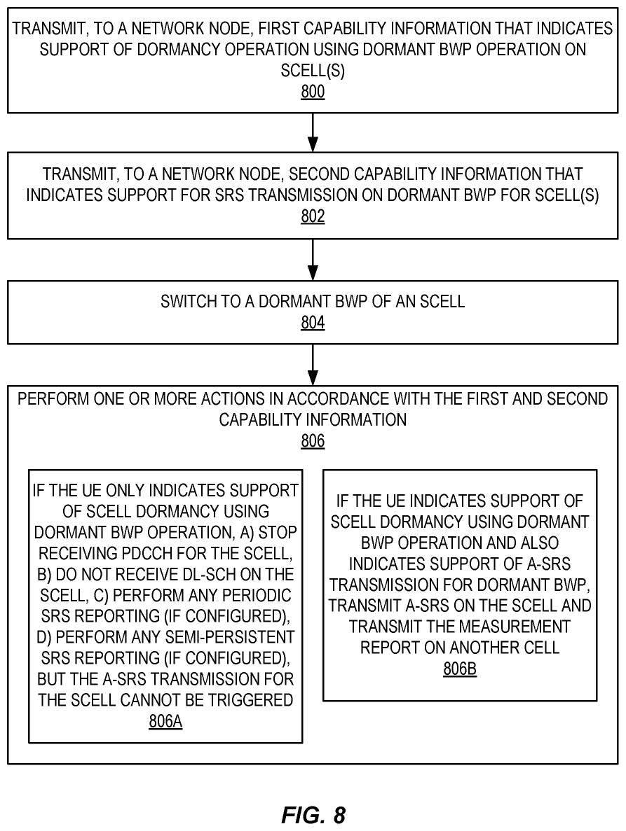

FIG. 8 is a flow chart that illustrates the operation of a UE 512 in accordance with some embodiments of the present disclosure. Optional steps are represented by dashed lines/boxes. As illustrated, the UE 512 indicates a first capability indicating support of dormant BWP operation for one or more SCells (step 800). In other words, the UE 512 transmits the first capability (also referred to herein as first capability information) to a network node. The UE 512 may indicate a separate second capability indicating support of SRS transmission on dormant BWP for one or more SCells (step 802). In other words, the UE 512 may transmit second capability (also referred to herein as second capability information) to a network node (e.g., the same network node to which the first capability information is transmitted).

The UE 512 is switched to a dormant BWP of an SCell (step 804). The UE 512 performs one or more actions in accordance with the first and second capability information (step 806), such as transmitting or receiving SRSs and measurement reports.

In one embodiment, if the UE 512 indicates support of SCell dormancy using dormant BWP operation without indicating support of A-SRS transmission for dormant BWP, when the UE 512 is switched to a dormant BWP of an SCell, the UE 512 a) stops receiving PDCCH for the SCell, b) does not receive DL-SCH on the SCell, c) performs any periodic SRS reporting (if configured), d) performs any semi-persistent SRS reporting (if configured), but the A-SRS transmissions for the SCell cannot be triggered for that UE 512 (step 806A).

If the UE 512 indicates support of SCell dormancy using dormant BWP operation and also indicates support of A-SRS transmissions for dormant BWP, when the UE 512 is switched to dormant BWP of an SCell, the UE 512 can transmit A-SRS on the SCell and transmit the measurement report on another cell (e.g., PCell/PSCell or another scheduling cell) (step 806B). The PDCCH to trigger the A-SRS transmission on the dormant BWP of SCell can be received by the UE 512 on another cell (e.g., PCell/PSCell). In addition to A-SRS transmissions, the UE 512 can perform other operation(s) (e.g., any one or more and possibly all of operations a)-d) mentioned above) when switched to dormant BWP.

The second UE capability can include one or more parameter settings associated with SRS transmission on the dormant BWP or associated with the A-SRS reporting on another cell (such as a PCell). The one or more parameters can include, e.g., an aperiodic SRS triggering offset, a minimum value of A-SRS triggering offset, etc. The one or more parameters can include a gap between the end of PDCCH on triggering cell and start of SRS transmission on the triggered cell. This gap can be in the units of absolute time (ms) or in units of PDCCH symbols. An example with PDCCH symbols shown below. This can be a first set of values that a UE can indicate it supports. The NW can suitably configure the UE with SRS transmission in the dormant BWP and reporting based on the UE reported value.

| PDCCH SCS | Gap (in PDCCH symbols) |
|---|---|
| 15 kHz | 14 = (1 ms) |
| 30 kHz | 14 = (0.5 ms) |
| 60 kHz | 28 = (0.5 ms) |
| 120 kHz | 48 = (0.5 ms) |

The UE 512 may indicate a different value of the gap based on the SCell dormancy transition time that it reports. Thus, if the UE 512 indicates 3 ms for dormancy/non-dormancy transition, the same 3 ms can be used as the minimum gap for configuring SRS transmission in dormant BWP.

The minimum value of A-SRS triggering offset can be dependent on the SCS of triggering cell (e.g., PDCCH of primary cell if primary cell is triggering cell) and the SCS of the secondary cell (cell and BWP on which the A-SRS is triggered).

In another example, using an assistance signaling framework, the UE 512 can inform the network (e.g., a base station 502) of a preferred A-SRS triggering offset or minimum gap that the UE 512 prefers for dormant BWP operation. The network can use this for properly configuring the triggering offsets for the dormant BWP. The preferred A-SRS triggering offset can be different than the preferred A-SRS triggering offset the UE 512 can report for a BWP other than dormant BWP.

The UE 512 indication of support of SRS transmission on dormant BWP can be different from the capability that UE 512 uses to indicate support of SRS transmission on BWP other than dormant BWP.

For periodic SRS, the UE 512 can indicate a parameter that indicates a minimum periodicity that the UE 512 would like. For example, if SRS is periodically configured every 1 ms, then the UE 512 cannot save any power in dormant BWP. So, the UE 512 may indicate that it prefers a period such as min 5 ms or min 10 ms. The network can configure the UE 512 appropriately with P-SRS.

In some cases, the UE 512 may indicate the capability to support A-SRS measurement on dormant BWP only if the UE 512 also indicates the capability to support operation using a minimum scheduling offset (K2 configuration) between PDCCH reception and corresponding PUSCH/aperiodic SRS triggering by the PDCCH.

In some cases, the UE 512 may indicate the capability to support A-SRS on dormant BWP only for certain CA cases, e.g. for case when the triggering PDCCH on cell 1 and the corresponding SRS on cell 2 with dormant BWP on which the SRS is transmitted have different SCS (sub-carrier spacing) configuration.

An example of capability description is shown below.

| | | | | | Type |
|---|---|---|---|---|---|
| | | | | | (the ‘type’ definition |
| | | | | | from UE features should be |
| | | | | | based on the granularity of |
| | | | | | 1) Per UE or |
| | | | | | 2) Per Band or |
| | | | Prerequisite | Consequence if the | 3) Per BC or |
| | | | feature | feature is not | 4) Per FS or |
| Index | Feature group | Components | groups | supported by the UE | 5) Per FSPC) |
| 18-4 | SCell | Support for | | | Per UE |
| | dormancy | SCell dormancy | | | |
| | within active | indication sent | | | |
| | time | within the active | | | |
| | | time on PCell | | | |
| | | with DCI format | | | |
| | | 0_1/1_1 | | | |
| 18-4e | Aperiodic SRS | Support for A- | 18-4 | UE cannot be | Per band per band |
| | transmission on | SRS | | configured with | combination |
| | SCell | transmission on | | A-SRS | |
| | dormancy | dormant SCell | | transmission on | |
| | outside active | and | | dormant BWP | |
| | time | corresponding | | | |
| | | trigger on | | | |
| | | another cell | | | |
| 18-4e | Periodic SRS | Support for P- | 18-4 | UE cannot be | Per band per band |
| | transmission on | SRS | | configured with | combination |
| | SCell | transmission on | | P-SRS | |
| | dormancy | dormant SCell. | | transmission on | |
| | outside active | | | dormant BWP | |
| | time | | | | |

Another embodiment is described below:

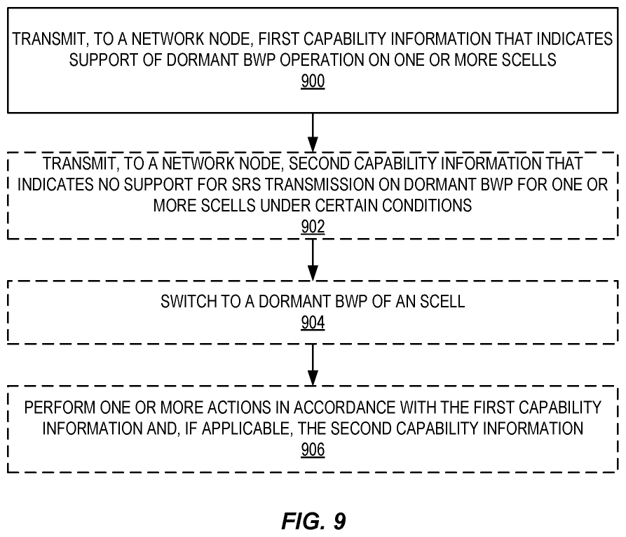

In this embodiment, as illustrated in FIG. 9, a UE 512 indicates a first capability that indicates that the UE 512 supports dormant BWP operation for one or more SCells (step 900). The UE 512 may indicate a second capability that indicates that the UE 512 does NOT support SRS transmission on dormant BWP for one or more SCells under certain conditions (step 902). The second UE capability can include one or more parameter settings associated with SRS transmission on the dormant BWP or associated with the A-SRS reporting on another cell (such as a SCell). The one or more parameters can include, e.g., an aperiodic SRS triggering offset, a minimum value of A-SRS triggering offset, etc.

A UE 512 indicating the first capability only (i.e., indicating on that the UE 512 supports dormant BWP operation for one or more SCells) can be configured with dormant BWP and SRS transmission on the dormant BWP.

A UE 512 indicating both capabilities (i.e., indicating on that the UE 512 supports dormant BWP operation for one or more SCells and also indicating that the UE 512 does NOT support of SRS measurement on a dormant BWP for one or more SCells under certain conditions) cannot be configured with dormant BWP and SRS transmission on the dormant BWP under those certain conditions.

The UE 512 is switched to a dormant BWP of an SCell (step 904). The UE 512 performs one or more actions in accordance with the first and second capability information (step 906). If UE 512 indicated the first capability only (i.e., indicating on that the UE 512 supports dormant BWP operation for one or more SCells), the UE 512 can be configured with dormant BWP and SRS transmission on the dormant BWP and, therefore, the UE 512 operates accordingly. If the UE 512 indicated both capabilities (i.e., indicates that the UE 512 supports dormant BWP operation for one or more SCells and also indicates that the UE 512 does NOT support of SRS measurement on a dormant BWP for one or more SCells under certain conditions), the UE 512 cannot be configured with a dormant BWP and SRS transmission on the dormant BWP under those certain conditions and, as such, the UE 512 operates accordingly.

### Additional Description

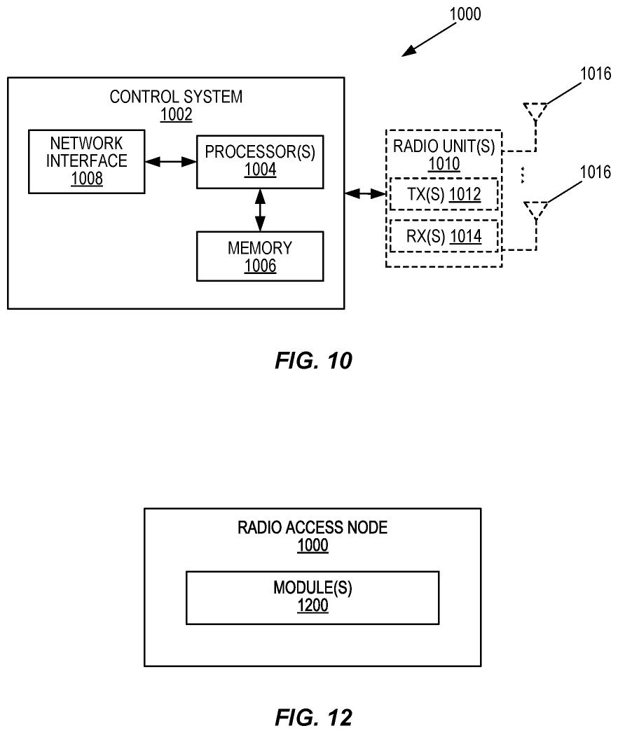

FIG. 10 is a schematic block diagram of a network node 1000 according to some embodiments of the present disclosure. Optional features are represented by dashed boxes. The network node 1000 may be, for example, a base station 502 or 506 or a network node that implements all or part of the functionality of the base station 502 or gNB described herein. As illustrated, the network node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the network node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a network node as described herein. In some embodiments, the function(s) are implemented in software that is stored, e.g., in the memory 1006 and executed by the one or more processors 1004.

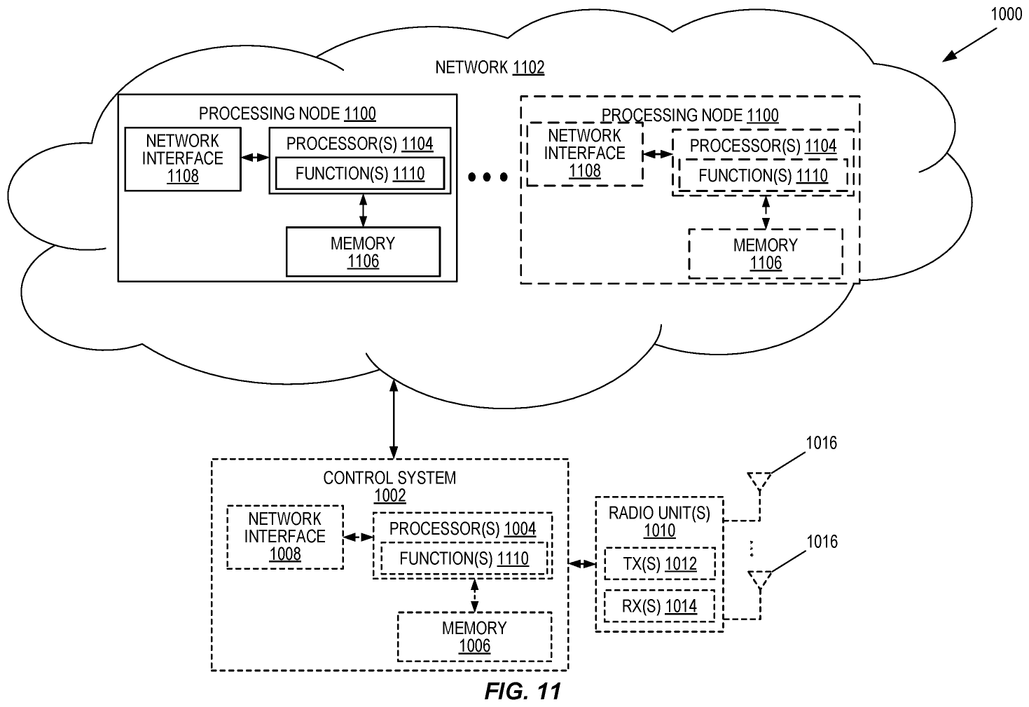

FIG. 11 is a schematic block diagram that illustrates a virtualized embodiment of the network node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 1000 in which at least a portion of the functionality of the network node 1000 is implemented as a virtual component(s) (e.g., via a virtual machine(s) executing on a physical processing node(s) in a network(s)). As illustrated, in this example, the network node 1000 may include the control system 1002 and/or the one or more radio units 1010, as described above. The control system 1002 may be connected to the radio unit(s) 1010 via, for example, an optical cable or the like. The network node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the network node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the network node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of network node 1000 or a node (e.g., a processing node 1100) implementing one or more of the functions 1110 of the network node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the network node 1000 according to some other embodiments of the present disclosure. The network node 1000 includes one or more modules 1200, each of which is implemented in software. The module(s) 1200 provide the functionality of the network node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

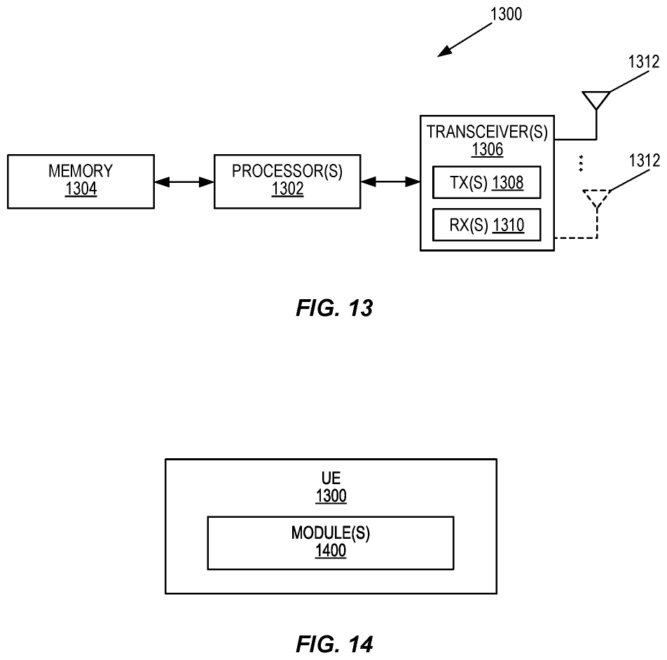

FIG. 13 is a schematic block diagram of a wireless communication device 1300 according to some embodiments of the present disclosure. The wireless communication device 1300 may be, for example, the UE 512 described herein. As illustrated, the wireless communication device 1300 includes one or more processors 1302 (e.g., CPUs, ASICs, FPGAs, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a wireless communication device (512), comprising: transmitting (600), to a network node, first capability information that indicates that the wireless communication device (512) supports secondary cell, SCell, dormancy operation using a dormant bandwidth part, BWP, for one or more SCells; and transmitting (602), to the network node, second capability information that indicates whether the wireless communication device (512) supports aperiodic channel state information, A-CSI, measurement on a dormant BWP of one or more SCells.

Embodiment 2: The method of embodiment 1 further comprising: switching (604) to a dormant BWP of an SCell; and, upon switching (604) to the dormant BWP of the SCell, performing (606) one or more actions in accordance with the first capability information and the second capability information.

Embodiment 3: The method of embodiment 2 wherein the second capability information indicates that the wireless communication device (512) does not supports A-CSI measurement on a dormant BWP of one or more SCells, the one or more actions comprise: (a) stops receiving PDCCH for the SCell; (b) does not receive DL-SCH on the SCell; (c) performs any periodic CSI reporting (if configured); (d) performs any semi-persistent CSI reporting (if configured); or (e) a combination of any two or more of (a)-(d).

Embodiment 4: The method of embodiment 3 wherein A-CSI measurements for the SCell cannot be triggered for the wireless communication device (512).

Embodiment 5: The method of embodiment 2 wherein the second capability information indicates that the wireless communication device (512) does support A-CSI measurement on a dormant BWP of one or more SCells, the one or more actions comprise: measuring A-CSI using channel state information reference signal, CSI-RS, on the SCell; and transmitting, on a cell other than the SCell, a measurement report that comprises at least a subset of the A-CSI measurements or information derived from at least a subset of the A-CSI measurements.

Embodiment 6: The method of embodiment 5 wherein a PDCCH that triggers the A-CSI measurement on the dormant BWP of the SCell is received by the wireless communication device (512) on a cell other than the SCell.

Embodiment 7: The method of embodiment 5 or 6 wherein a cell on which the PDCCH that triggers the A-CSI measurement on the dormant BWP of the SCell is received by the wireless communication device (512) is a same cell on which the wireless communication device (512) transmits the measurement report.

Embodiment 8: The method of embodiment 5 or 6 wherein a cell on which the PDCCH that triggers the A-CSI measurement on the dormant BWP of the SCell is received by the wireless communication device (512) is a cell other than a cell on which the wireless communication device (512) transmits the measurement report.

Embodiment 9: The method of any one of embodiments 1 to 8 wherein the second capability information comprises one or more parameters associated with A-CSI measurement on a dormant BWP of one or more SCells and/or one or more parameters associated with A-CSI measurement reporting on another cell.

Embodiment 10: The method of embodiment 9 wherein the one or more parameter comprises an aperiodic CSI triggering offset and/or a minimum value of an A-CSI triggering offset.

Embodiment 11: The method of embodiment 9 or 10 wherein the one or more parameter comprises a parameter that defines a gap between an end of a PDCCH on a triggering cell that triggers A-CSI measurement and a start of CSI-RS on a cell on which the A-CSI measurement is triggered.

Embodiment 12: The method of embodiment 11 wherein a value of the parameter that defines the gap is based on an SCell dormancy transition time (e.g., that the wireless communication device (512) reports).

Embodiment 13: The method of any one of embodiments 9 to 12 wherein the one or more parameters comprise a minimum value of an A-CSI triggering offset, and the minimum value of the A-CSI triggering offset is dependent on a subcarrier spacing of a cell on which a PDCCH triggering A-CSI measurement is received by the wireless communication device (512).

Embodiment 14: The method of any one of embodiments 1 to 13 wherein the second capability information indicates a capability to support A-CSI measurement on a dormant BWP of one or more SCells only if the wireless communication device 512 also indicates a capability to support operation using a minimum scheduling offset between PDCCH reception and corresponding PDSCH/aperiodic CSI-RS triggering by the PDCCH.

Embodiment 15: The method of any one of embodiments 1 to 14 further comprising transmitting assistance information to the network node that informs the network node of a preferred A-CSI triggering offset or a minimum gap for dormant BWP operation.

Embodiment 16: The method of any one of embodiments 1 to 15 wherein the second capability information is different from capability information that the wireless communication device (512) uses to indicate support of A-CSI measurement on BWP(s) other than dormant BWP(s).

Embodiment 17: The method of embodiment 1 or 2 wherein the second capability information indicates that the wireless communication device (512) does not support A-CSI measurement on a dormant BWP of one or more SCells under one or more certain conditions.

Embodiment 18: A method performed by a wireless communication device (512), comprising: transmitting (800), to a network node, first capability information that indicates that the wireless communication device (512) supports secondary cell, SCell, dormancy operation using a dormant bandwidth part, BWP, for one or more SCells; and transmitting (802), to the network node, second capability information that indicates whether the wireless communication device (512) supports sounding reference signal, SRS, transmission on a dormant BWP of one or more SCells.

Embodiment 19: The method of embodiment 19 further comprising: switching (804) to a dormant BWP of an SCell; and, upon switching (804) to the dormant BWP of the SCell, performing (806) one or more actions in accordance with the first capability information and the second capability information.

Embodiment 20: The method of embodiment 19 wherein the second capability information indicates that the wireless communication device (512) does not supports SRS transmission on a dormant BWP of one or more SCells, the one or more actions comprise: (a) stops receiving PDCCH for the SCell; (b) does not receive DL-SCH on the SCell; (c) performs any periodic SRS reporting (if configured); (d) performs any semi-persistent SRS reporting (if configured); or (e) a combination of any two or more of (a)-(d).

Embodiment 21: The method of embodiment 20 wherein SRS transmission for the SCell cannot be triggered for the wireless communication device (512).\

Embodiment 22: The method of embodiment 19 wherein the second capability information indicates that the wireless communication device (512) does support SRS transmission on a dormant BWP of one or more SCells, the one or more actions comprise transmitting aperiodic SRS on the SCell.

Embodiment 23: The method of embodiment 22 wherein the one or more actions further comprise transmitting a measurement report on a cell other than the SCell.

Embodiment 24: The method of any one of embodiments 18 to 23 wherein the second capability information comprises one or more parameters associated with SRS transmission on a dormant BWP of one or more SCells and/or one or more parameters associated with A-SRS reporting on another cell.

Embodiment 25: The method of embodiment 24 wherein the one or more parameter comprises an aperiodic SRS triggering offset and/or a minimum value of an A-SRS triggering offset.

Embodiment 26: The method of embodiment 24 or 25 wherein the one or more parameter comprises a parameter that defines a gap between an end of a PDCCH on a triggering cell that triggers SRS transmission and a start of SRS transmission on a cell on which the SRS transmission is triggered.

Embodiment 27: The method of embodiment 26 wherein a value of the parameter that defines the gap is based on an SCell dormancy transition time (e.g., that the wireless communication device (512) reports).

Embodiment 28: The method of any one of embodiments 24 to 27 wherein the one or more parameters comprise a minimum value of an A-SRS triggering offset, and the minimum value of the A-SRS triggering offset is dependent on a subcarrier spacing of a cell on which a PDCCH triggering SRS transmission is received by the wireless communication device (512).

Embodiment 29: The method of any one of embodiments 18 to 28 further comprising transmitting assistance information to the network node that informs the network node of a preferred A-SRS triggering offset or a minimum gap for dormant BWP operation.

Embodiment 30: The method of embodiment 18 or 19 wherein the second capability information indicates that the wireless communication device (512) does not support A-SRS measurement on a dormant BWP of one or more SCells under one or more certain conditions.

Embodiment 31: A wireless communication device (512) adapted to perform the method of any one of embodiments 1 to 30.

Those skilled in the art will recognize improvements and modifications to the embodiments of the present disclosure. All such improvements and modifications are considered within the scope of the concepts disclosed herein.

1. A method performed by a wireless communication device, comprising:
transmitting, to a network node, first capability information that indicates that the wireless communication device supports secondary cell (SCell) dormancy operation using a dormant bandwidth part (BWP) for one or more SCells; and
transmitting, to the network node, second capability information that indicates whether the wireless communication device supports sounding reference signal (SRS) transmission on a dormant BWP of one or more SCells.

2. The method of claim 1 further comprising:
switching to a dormant BWP of an SCell; and
upon switching to the dormant BWP of the SCell, performing one or more actions in accordance with the first capability information and the second capability information.

3. The method of claim 2 wherein the second capability information indicates that the wireless communication device does not support aperiodic SRS transmission on a dormant BWP of one or more SCells, and the one or more actions comprise:
a) stop receiving Physical Downlink Control Channel (PDCCH) for the SCell;
b) do not receive Downlink Shared Channel (DL-SCH) on the SCell
c) perform periodic SRS reporting;
d) perform any semi-persistent SRS reporting; or
e) a combination of any two or more of a)-d).

4. The method of claim 3 wherein aperiodic SRS transmission for the SCell cannot be triggered for the wireless communication device.

5. The method of claim 2 wherein the second capability information indicates that the wireless communication device does support aperiodic SRS transmission on a dormant BWP of one or more SCells, and the one or more actions comprise transmitting aperiodic SRS on the SCell.

6. The method of claim 2 wherein the second capability information indicates that the wireless communication device does support periodic SRS transmission on a dormant BWP of one or more SCells, and the one or more actions comprise transmitting periodic SRS on the SCell.

7. The method of claim 5 wherein the one or more actions further comprise transmitting a measurement report on a cell other than the SCell.

8. The method of claim 1 wherein the second capability information comprises one or more parameters comprising: (i) one or more parameters associated with SRS transmission on a dormant BWP of one or more SCells, (ii) one or more parameters associated with A-SRS transmission on another cell, or (iii) both (i) and (ii).

9. The method of claim 8 wherein the one or more parameters comprises an aperiodic SRS triggering offset or a minimum value of an A-SRS triggering offset.

10. The method of claim 8 wherein the one or more parameters comprise a parameter that defines a gap between an end of a Physical Downlink Control Channel (PDCCH) on a triggering cell that triggers aperiodic SRS transmission and a start of SRS transmission on a cell on which the SRS transmission is triggered.

11. The method of claim 10 wherein a value of the parameter that defines the gap is based on an SCell dormancy transition time that the wireless communication device reports.

12. The method of claim 8 wherein the one or more parameters comprise a minimum value of an A-SRS triggering offset, and the minimum value of the A-SRS triggering offset is dependent on a subcarrier spacing of a cell on which a Physical Downlink Control Channel (PDCCH) triggering aperiodic SRS transmission is received by the wireless communication device.

13. The method of claim 8 wherein the one or more parameters comprise a minimum value of an A-SRS triggering offset, and the minimum value of the A-SRS triggering offset is dependent on a subcarrier spacing of a cell on which a Physical Downlink Control Channel (PDCCH) triggering aperiodic SRS transmission is received by the wireless communication device and the subcarrier spacing of the SCell.

14. The method of claim 1 further comprising transmitting assistance information to the network node that informs the network node of a preferred A-SRS triggering offset or a minimum gap for dormant BWP operation.

15. The method of claim 1 wherein the second capability information indicates that the wireless communication device does not support A-SRS transmission on a dormant BWP of one or more SCells under one or more certain conditions.

16-17. (canceled)

18. A wireless communication device comprising:
one or more transmitters;
one or more receivers; and
processing circuitry associated with the one or more transmitters and the one or more receivers, the processing circuitry configured to cause the wireless communication device to:
transmit, to a network node, first capability information that indicates that the wireless communication device supports secondary cell (SCell) dormancy operation using a dormant bandwidth part, BWP, for one or more SCells; and
transmit, to the network node, second capability information that indicates whether the wireless communication device supports sounding reference signal (SRS) transmission on a dormant BWP of one or more SCells.

19. The wireless communication device of claim 18 wherein the processing circuitry is further configured to cause the wireless communication device to perform comprising:
switching to a dormant BWP of an SCell; and
upon switching to the dormant BWP of the SCell, performing one or more actions in accordance with the first capability information and the second capability information.

20-41. (canceled)

42. A non-transitory computer-readable storage medium, the medium having executable instructions stored thereon that, when executed by a processing device of a wireless communication device, cause the wireless communication device to perform operations comprising:
transmitting, to a network node, first capability information that indicates that the wireless communication device supports secondary cell (SCell) dormancy operation using a dormant bandwidth part, BWP, for one or more SCells; and
transmitting, to the network node, second capability information that indicates whether the wireless communication device supports sounding reference signal (SRS) transmission on a dormant BWP of one or more SCells.

43. The computer-readable storage medium of claim 42, wherein the instructions stored thereon cause the processing device to perform operations further comprising:
switching to a dormant BWP of an SCell; and
upon switching to the dormant BWP of the SCell, performing one or more actions in accordance with the first capability information and the second capability information.

44. The computer-readable storage medium of claim 43, wherein the second capability information indicates that the wireless communication device does not support aperiodic SRS transmission on a dormant BWP of one or more SCells, and the one or more actions comprise:
a) stop receiving Physical Downlink Control Channel (PDCCH) for the SCell;
b) do not receive Downlink Shared Channel (DL-SCH) on the SCell
c) perform periodic SRS reporting;
d) perform any semi-persistent SRS reporting; or
e) a combination of any two or more of a)-d).
